(19) United States
(12) Patent Application Publication
(10) Pub. No.: US 2004/0162759 A1
(43) Pub. Date: Aug. 19, 2004

(54) Advertising on video event display systems

(76) Inventor: Daniel Willis, Stittsville (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/775,247

(22) Filed: Feb. 11, 2004

Related U.S. Application Data
(63) Continuation-in-part of application No. 10/232,603, filed on Sep. 3, 2002.

(51) Int. Cl. G06F 17/60

(52) U.S. Cl. 705/14

(57) ABSTRACT

A method of advertising for use by a Gaming Service Provider providing as set-top box in connection with a wide area network is disclosed. The set-top box functions as a customer gaming console. The method includes the steps of providing an identification from the customer gaming console to a Gaming Service Provider providing an advertisement out of a plurality of advertisements to the customer gaming console, initializing the customer gaming console for playing a game and for displaying the advertisement, playing a game on the customer gaming console, and displaying the advertisement on the customer gaming console, when the game is not being played. Alternatively, the steps of the method are not initialized by the Gaming service provider, but from the gaming console site. Further, certain games played on the gaming console incorporate advertisements into their gaming environments.

The present application is a continuation in part of U.S. patent application Ser. No. 10/232,603 filed on Sep. 3, 2002.

### FIELD OF THE INVENTION

The present invention relates to advertising on video event display systems, and particularly to advertising on video event display systems connected to a wide area network and comprising a set-top box.

### BACKGROUND OF THE INVENTION

Advertising is closely related to common mass media both old and new, be it radio and television broadcast, or the Internet network. For an advertiser, the value of advertising is the ability to direct an advertisement to a specific group of consumers. Control over the advertisement in terms of when, where, how, and to whom an advertisement is communicated is of paramount importance to the advertiser. Thus, targeted advertising, which offers compelling content aimed at a specific demographic market, represents the future of advertising, especially for new media such as the Internet.

The general idea of targeted advertising on the Internet is well advocated, as described for example in U.S. Pat. No. 6,339,761 to Cottingham, issued Jan. 15, 2002. With the major advances in Internet-supporting software as well as Internet data protocols, it has become easier to track who a person is, and what she or he likes. Therefore, both the frequency as well the success rate of targeted advertising on the Internet are likely to increase in the near future.

Until the present, the main efforts in advertising on the Internet network have been directed towards placing advertisements within specific websites. Thus, the current systems and methods for advertising on the Internet network are developed having in mind Internet Service Providers (ISP) as main users. There are other major developments taking place, which hold a promising future for advertising on the Internet network, such as on-line computer gaming. During the last couple of years, on-line computer gaming has gained increasing popularity, and different Gaming Service Providers (GSP) have established themselves on the Internet network. On-line computer gaming is fast becoming a major money generating competitive virtual sport with tournament organizations and ranking services dedicated to providing the online community with the latest information and current rankings of global Internet gamers and game players. An interactive game server and online community forum is for example described in U.S. Pat. No. 6,339,761 to Sparks II, issued Mar. 5, 2002.

Many of the known systems used for gaming combine gaming and television experiences in that a gaming console (GC) adapts a game for being played on a television set. The television set often is an analog television set. If the analog television set is further used to receive digital television broadcast, a set-top box is needed to adapt a digital television signal to be capable of display on the analog television set, or to extract data from a digital television signal for display on an analog television set. Advantageously, the set-top box is used as gaming console, for example by executing software that emulates a gaming console. Alternatively, a gaming console is used as set-top box. In this case, a single hardware device serves as gaming console and as set-top box, and is referred to as a set-top box gaming system. One possible way to realize a set-top box gaming system is for example executing on a gaming console software that emulates a set-top box. Other possible solutions are conceivable, by which the set-top box gaming system is realized. In case of the set-top box gaming system, all the ideas developed above for advertising in connection with gaming systems equally apply to advertising in connection with set-top boxes.

In view of the combination of gaming and television services, the term gaming as it is understood in today's technical world needs to be re-evaluated. Despite the competitive and interactive character inherent to on-line gaming, gaming is in the first place a recreational activity. During a gaming experience, the gamer submerges into a virtual world, in which he or she is faced with new and challenging adventures and experiences. In this sense, even watching a movie might be considered a gaming activity. Many of the ideas outlined above referring to the availability and distribution of games also apply to movies, with pay-per-view services and movie channels being readily available. This consideration adds another dimension to the set-top box gaming system.

In view of the financial benefits resulting for providers of services utilizing the Internet network, in view of the growing popularity of on-line gaming, as well as in view of the potential impetus interactive gaming is able to provide in the fields of advertising and marketing, it is highly advantageous to combine the common ideas and strategies of advertising on the Internet network with interactive entertainment on the Internet network in general, and specifically with on-line gaming. It is of further advantage to use a set-top box gaming system as medium for advertisement, the set-top box gaming system being able to emulate a gaming console, and providing access to gaming and especially interactive gaming as well as digital television services.

### SUMMARY OF THE INVENTION

In accordance with an aspect of the instant invention, there is provided a method of advertising for use by a Service Provider providing a video event display system connected with a wide area network, the method comprising the steps of: providing an identification from the video event display system to the Service Provider; providing an advertisement from a plurality of advertisements to the video event display system; initializing the video event display system for displaying a video event and for displaying the advertisement; displaying a video event on the video event display system; and displaying the advertisement on the video event display system, when the video event is not being displayed.

In accordance with an aspect of the instant invention, there is further provided a storage medium having stored therein data, the data for performing the steps of: providing an identification from a video event display system to a Service Provider; providing an advertisement from a plurality of advertisements to the video event display system; initializing the video event display system for displaying a video event and for displaying the advertisement; displaying a video event on the video event display system; and displaying the advertisement on the video event display system, when the video event is not being displayed.

In accordance with another aspect of the instant invention, there is provided a storage medium having stored therein data, the data for performing the steps of: loading a video event stored on a local storage device onto a video event display system; loading an advertisement out of a plurality of advertisements stored on the local storage device to the video event display system; initializing the video event display system for displaying the video event and for displaying the advertisement; displaying the video event on the video event display system; and displaying the advertisement on video event display system.

In accordance with another aspect of the instant invention, there is provided a system for advertising for use by a Service Provider providing a video event display system connected with a wide area network, the method comprising the steps of: means for providing an identification from the video event display system to the Service Provider; means for providing an advertisement from a plurality of advertisements to the video event display system; means for initializing the video event display system for displaying a video event and for displaying the advertisement; means for displaying a video event on the video event display system; and means for displaying the advertisement on the video event display system, when the video event is not being displayed.

### BRIEF DESCRIPTION OF THE DRAWINGS

Exemplary embodiments of the present invention will be described in conjunction with the following drawings, in which similar reference numbers designate similar items:

FIG. 1 displays a simplified flow diagram for advertisement display on a video event display system (VDS) according to a first embodiment of the present invention;

FIG. 2 displays a simplified flow diagram for advertisement display on a video event display system (VDS) including the steps of establishing a customer's personal profile (CPP) and assessing the game console's availability according to a second embodiment of the present invention;

FIG. 3 displays a simplified flow diagram for advertisement on a video event display system (VDS), further including the step of storing advertisements in a temporary buffer (TB) according to a third embodiment of the present invention;

FIG. 4 displays a simplified flow diagram for advertising on a video event display system (VDS) according to a fourth embodiment of the present invention;

FIG. 5 displays a schematic screenshot of a video event displayed on video event display system (VDS), incorporating advertisement; and

FIG. 6 displays another schematic screenshot of a video event displayed on a video event display system (VDS), incorporating animated advertisement.

### DETAILED DESCRIPTION OF THE INVENTION

The present invention is now described with respect to displaying advertisements on a customer video event display system (VDS), which is used by a customer of a Service Provider (SP) to display a video event. The VDS is connected to a wide area network, such as for example the Internet network. The VDS comprises a device for receiving video signals from the wide area network, the device being for example a set-top box, a gaming console, or the like. The VDS further comprises a device for displaying the video signal, as for example a monitor, an analog television set, or a digital television set. The video events provided by the service provider include single user games, interactive multi-player on-line games, movies, and other video events.

In one example of the instant invention, the video event is a game, and the VDS comprises a gaming console (GC). Alternatively, the VDS comprises a set-top box emulating a GC. The customer starts the game on the gaming console (GC), and connects to the Service Provider to retrieve particular gaming scenarios, or to participate in an interactive gaming situation involving a plurality of interactive gaming participants. Optionally, the customer retrieves gaming software from the Service Provider. Before an advertisement is displayed on the video event display system (VDS), the customer establishes a connection to the Service Provider (SP), and requests particular gaming information. After the connection has been successfully established, the Service Provider (SP) sends the requested information, and optionally additional advertisements to the customer's gaming console (GC).

In the example given above, the service provider (SP) is a Gaming Service Provider (GSP). In case that the video events provided by the SP are movies, the Service Provider (SP) is a Movie Provider (MP). Other Service Providers providing other video events are conceivable to a person of skill in the art.

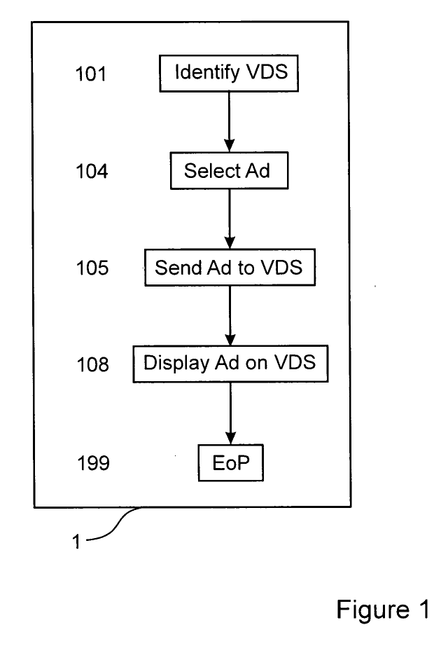

Referring now to FIG. 1, a simplified flow diagram is shown, which illustrates the principle idea of a first embodiment of the present invention. The procedure 1 of displaying an advertisement on a video event display system (VDS) is initiated with an identification step 101. After the customer has established the connection with the Service Provider (SP), and has sent his or her video event request, the SP identifies the video event display system (VDS). This identification step is for example performed by an analysis of the network address from which a particular user requests a connection to the Service Provide (SP), when for example the Internet network is used to establish the connection. Alternatively, the identification of the video event display system (VDS) is performed using a user identification and password system, or a related security system commonly used in remote access procedures. After the access authorization has been established, information about the hardware capabilities of the VDS is retrieved. This information is related to graphic capabilities, sound capabilities, memory, and other hardware details of the VDS. Once the identity of the video event display system has been established, the video event request is processed.

In a next step 104, the Service Provider (SP) selects an advertisement out of a plurality of advertisements. The advertisement is typically an electronic advertisement, stored on a data storage device of the SP, such as a hard disc. The electronic advertisement is stored according to common data formats, such as Graphic Interchange Format (GIF), Tagged Image File Format (TIFF), Motion Picture Entertainment Group (MPEG) format, or any other format that complies with the hardware configuration of the video event display system (VDS). Optionally, each advertisement is provided in at least one of several different formats with respect to requirements for memory and/or video and audio hardware support. According to the identity of the video event display system (VDS), a corresponding data format for a particular advertisement is selected.

Commonly, the Service Provider (SP) sells advertising space on a service site, and different advertisements provided by different advertisers constitute a pool of possible advertisements. The number of downloads of an advertisement to a video event display system (VDS) is possibly used to determine a pricing system for the cost of an advertisement being included in the pool of advertisements. Optionally, a bidding system is set up to assists the selection and pricing of advertisements. Proposed bids submitted by different advertisers are evaluated in real time in order to determine which particular advertisement will be displayed on a gaming console. Each proposed bid can specify a price or amount that the advertiser is willing to pay for the opportunity to display an advertisement. Such a bidding system, for example, is disclosed in U.S. Pat. No. 6,285,987 to Roth et al., issued Sep. 4, 2001.

Once the advertisement has been selected, it is sent to video event display system (VDS), step 105, and is displayed on the VDS, step 108. Depending on the format of the advertisement, the advertisement is for example displayed as a simple pop-up picture, as an animated sequence of pictures, as a sound supported picture, or as a short movie clip. After the advertisement is displayed, the end of the procedure 1 (EOP) of displaying an advertisement on the video event display system (VDS) is reached, step 199. Optionally, the procedure 1 is repeated. In this case, step 101 is possibly omitted, beginning the repeating procedure with step 104.

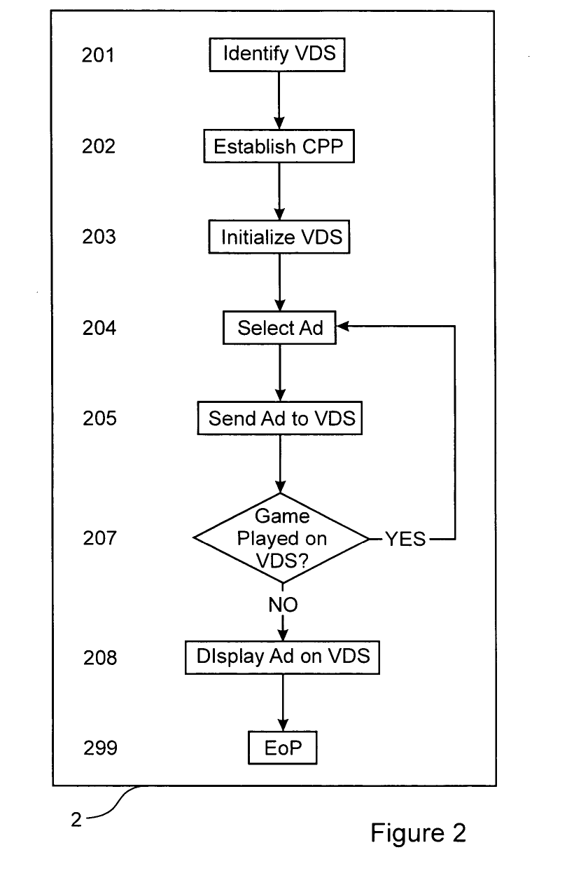

A variety of alternatives to the above-described procedure 1 are conceivable by those of skill in the art. An extended procedure 2 is now described with reference to FIG. 2, in which a simplified flow diagram illustrates the principle ideas of a second embodiment of the present invention. The procedure 2 is initiated with an identification step 201 that is similar to the above-described identification step 101. Again, access authorization as well as hardware configuration is ascertained. In a next step 202, a customer personal profile (CPP) is established. The customer personal profile (CPP) is accessed and modified by the customer, after a common verification procedure is executed, involving for example a user ID and a corresponding user password, or any other verification procedure commonly used a in remote access environment.

The CPP contains a variety of information regarding a specific customer. If the customer subscribes to a gaming service offered by a Gaming service Provider (GSP), the customer's video event display system (VDS) comprising a gaming console (GC), this information is for example personal information of the customer such as age, gender, marital status, occupation and so forth, voluntarily provided by the customer. Optionally, the customer personal profile (CPP) relates to a particular customer gaming console (GC) and contains a history of the games requested from the GC. Further optionally, the CPP contains information relating to interactive gaming, such as preferences for certain interactive scenarios, and the like.

In a following step 203, the video event display system (VDS) is initialized. In an initialization for interactive gaming for example, gaming information is downloaded from a GSP to the video event display system (VDS), and interactive gaming connections are established. In the initialization for display of advertisement, the VDS is prepared for displaying an advertisement, which includes steps such as freeing-up unneeded CPU resources, clearing unused random access memory (RAM), and other hardware related steps.

Next, an advertisement is selected, step 204. The selection process possibly occurs according to target group considerations, established by the customer personal profile (CPP), and/or according to a video event requested.

In addition, when the SP uses the Internet network to provide video events, cooperation with a customer's Internet Service Provider (ISP) allows for a more detailed user classification. Typically, the ISP has access to precise demographic data on each of the ISP customers. The ISP also has access to data on the periods of usage, including the type of customers accessing the Internet during such periods of usage. With this information, which is available only to the ISP, a profile is possibly compiled by the ISP. The profile provides precise information and demographic data on the ISP customers. Cottingham et al. teaches a method how this information is used to provide precise control over who receives an advertisement. When the information about a certain customer collected by the ISP is made available to the SP, provided that a certain customer subscribes to services of both the SP and the ISP, then the information is optionally used in selecting a targeted advertisement to be sent to the video event display system (VDS) of the certain customer. Furthermore, the history of Uniform Resource Locators (URL) requested by a certain customer is optionally used, to set up a detailed customer personal profile (CPP).

When a customer personal profile is analyzed, the customer is classified according to a set of predefined classes. Optionally, each advertisement out of the plurality of advertisements is classified as belonging to one or several of the predefined classes, and an advertisement is selected as to match best the classification of the customer.

After the advertisement has been selected, it is transmitted to the video event display system (VDS), step 205. Next, it is determined whether a video event is displayed on the video event display system (VDS), step 207. If a video event is displayed, than the procedure steps back to step 204, and the advertisement is resent to the VDS. If a video event is not displayed on the VDS, then the advertisement is displayed on the VPS, step 208, and the end of the procedure 2 (EOP) is reached, step 299. Inserting step 207 into the procedure ensures that displaying an advertisement most likely does not interfere with the customer displaying a video event. It is highly disadvantageous to the SP, when the service provided to the customer suffers a major loss in quality due to the incorporation of advertisement, since this is almost guaranteed to cause customer dissatisfaction.

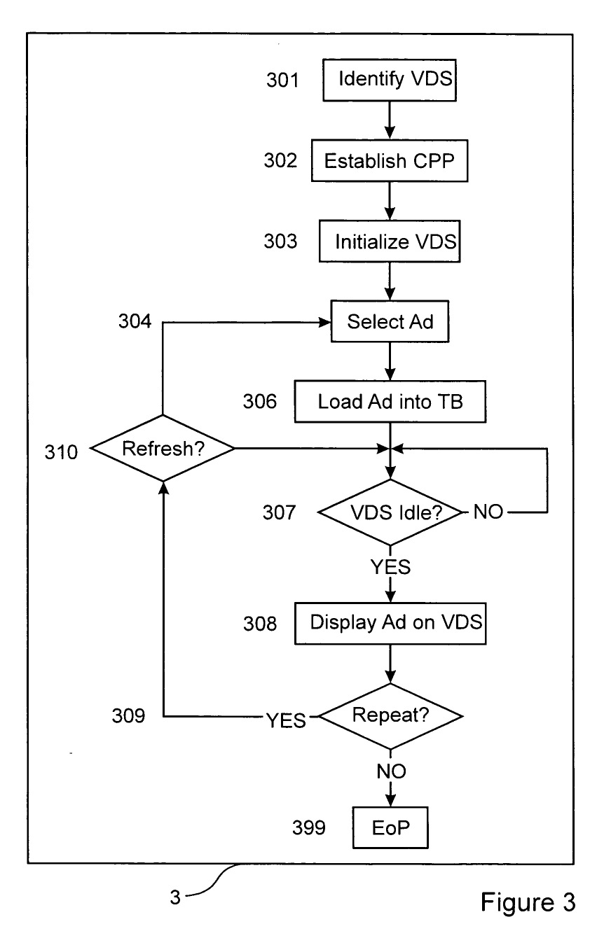

Referring now to FIG. 3, a simplified flow diagram is shown illustrating basic steps of an enhanced procedure 3 according to a third embodiment of the present invention. The procedure 3 begins with the identifying the a video event display system (VDS), step 301, followed by establishing a customer personal profile (CPP), step 302, initializing the VDS, step 303, and selecting an advertisement out of a plurality of advertisements, step 304. The steps 301, 302, 303, and 304 are similar to the steps 201, 202, 203, and 204, and similar considerations apply. In the next step 306, the selected advertisement is loaded into a temporary buffer (TB). There exist various possibilities how to set up a TB. For example, memory resources of the VDS are used as TB. Alternatively, memory resources of a connection device used to establish a connection between the VDS and the SP are used as temporary buffer (TB). This way, advertising on the VDS does not deplete hardware resources of the VDS, which in turn may possibly affect the video display experience of the customer. In case memory resources of the VDS are used as temporary buffer (TB), the initializing step 303 gains special importance as during this step flushing of memory resources of the VDS is performed, which then are used as TB.

After the advertisement has been loaded into the temporary buffer (TB), it is determined whether the video event display system (VDS) is idle, step 307. The VDS is idle, when for example the VDS is initialized, but no video event is being displayed on the VDS. The VDS is also idle, when the video event being displayed by the customer is paused or interrupted.

In case the VDS is idle, an advertisement is displayed on the VDS, step 308. After the advertisement has been displayed it is determined whether the step of displaying an advertisement is to be repeated, step 309. This decision-making process is optionally coupled to the price paid by the customer for the gaming service. A low rate for subscription to the SP is accompanied by a high frequency of advertisement. On the other hand, the customer possibly opts for a service, in which no advertisements are displayed, for a substantially higher subscription rate.

If the repeat-decision is positively answered, it is decided whether to refresh the temporary buffer (TB), or whether the advertisement previously displayed is lined-up for being repeatedly displayed, step 310. Optionally, a sequence of related advertisements has been loaded into the TB, which are then displayed in series, whenever the repeat-decision is positively answered.

If the refresh-decision is positive, the procedure steps back to step 304, and a new advertisement is selected out of the plurality of advertisements. The repeat step optionally not only reflects the pricing system applied for offering the gaming service to the customer, but also the pricing system for the advertiser. The price of the advertisement is determined considering both downloading the advertisement to the temporary buffer (TB), as well as the number of times the advertisement is actually displayed. If the repeat decision is negatively answered, the end of the procedure 3 (EOP) is reached, step 399. Optionally, the whole procedure 3 is repeated.

The above-described procedures 1, 2, and 3 have been described as being executed from the customer's gaming console (GC). Alternatively, the Service Provider (SP) performs the same procedures. In this case, for example, the advertisements are not downloaded by the customer VDS, but are uploaded to the customer VDS. Similar modifications apply to other steps of the above procedures 1, 2, and 3. Nevertheless, the basic principles and ideas for displaying an advertisement on a customer video event display system (VDS) remain the same.

Furthermore, it is noted that the procedures 1, 2, and 3 represent basic procedures, to be easily modified by those of skill in the art. For example, certain delay loops and waiting steps, affecting the time flow of the procedures, are implemented without difficulties.

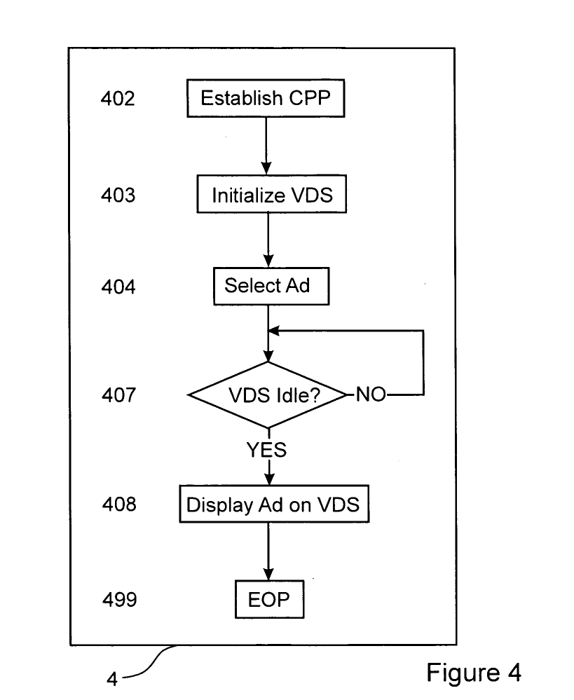

The above-described procedures are also applicable for advertising on a video event display system (VDS), which is not connected to a wide area network such as the Internet network, but which is connected to a local area network (LAN) or is used in a stand-alone fashion. In this case, a gaming cartridge or a compact disc on which games are stored typically takes on the function of the Service Provider (SP), and a simplified flow diagram for a basic procedure 4 is shown in FIG. 4. A customer personal profile (CPP) is established, step 402. This step is typically performed using information provided by the customer to the video event display system (VDS). Next, the VDS is initialized, step 403. In this step, a video event is typically loaded from a storage device such as a cartridge comprising read-only memory (ROM), or a compact disc. Next, an advertisement out of a plurality of advertisements is selected, step 404. Preferably, the plurality of advertisement is stored on the same storage device as the video event loaded to the customer VDS. Information provided in the CPP is used to select the advertisement. Optionally, the plurality of advertisements put on the storage device comply to a same customer classification as the video event stored on the storage device. It is then determined whether the customer VDS is idling, step 407, and in case the decision results in a negative answer, an advertisement is displayed, step 408. After the end of the procedure 4 (EOP) is reached, step 499, the procedure is optionally repeated. The same considerations and modifications described for procedures 1, 2, and 3 for displaying an advertisement on a customer video event display system (VDS) connected to a wide area network, apply to procedure 4 as well.

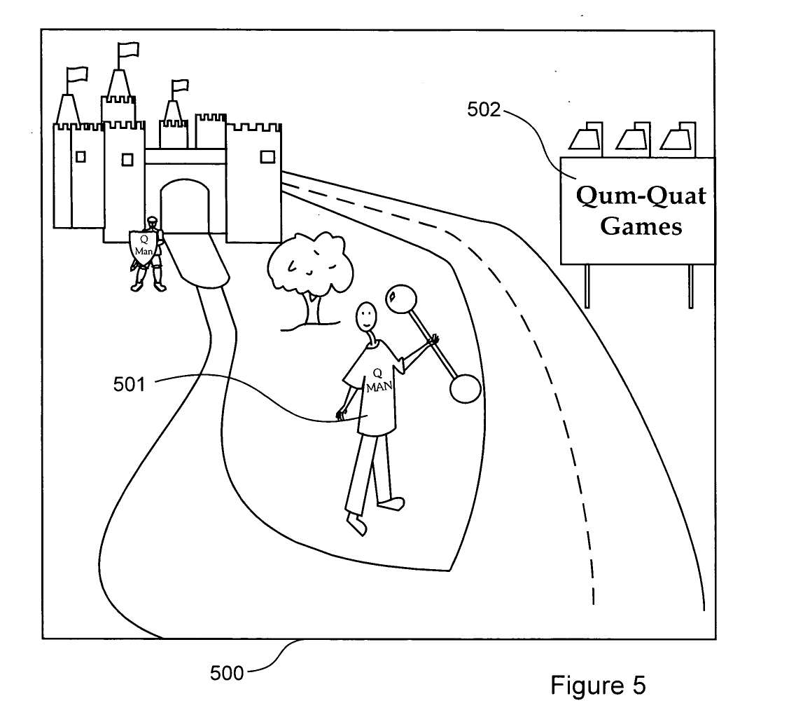

Referring now to FIG. 5, a schematic screenshot 500 is shown of a video event displayed on the video event display system (VDS). Here, the VDS offers designated advertising spaces and/or generic advertising logos displayed therein. Preferably, the locations of the designated advertising spaces and/or advertising logos are variable, and are selected in connection with a video event displayed on the VDS. For example, a designated advertising space 501 is associated with a T-shirt worn by a character being part of the video event, and it is used so that the character in the video event wears a shirt, which has emblazoned thereon the name of a product being advertised. In another example, a billboard being part of a city scenario, in which the video event takes place, displays the advertising logo of a given product 502. Optionally, other advertisements selected from a plurality of advertisements are displayed on the designated advertising space. The video event source provides strict guidelines for provision of new logos for use within the video event. Therefore, the steps of selecting an advertisement out of a plurality of advertisements, steps 104, 204, 304, and 404 of the methods illustrated above, are carried out in connection with information provided by the video event being displayed on the VDS. In this case, an advertisement out of the plurality of advertisements will be referred to as a logo. Thus, when a video event is initialized, it transmits to the SP a list of predetermined logo formats. Optionally, other information is included indicating a desirability/cost structure for each logo. Logos having the predetermined format are then provided from the SP to the VDS for display during the video event. The logos are positioned in the designated advertising space provided by the video event displayed on the VDS. This procedure creates an equivalent to “product placements” as provided in the movies.

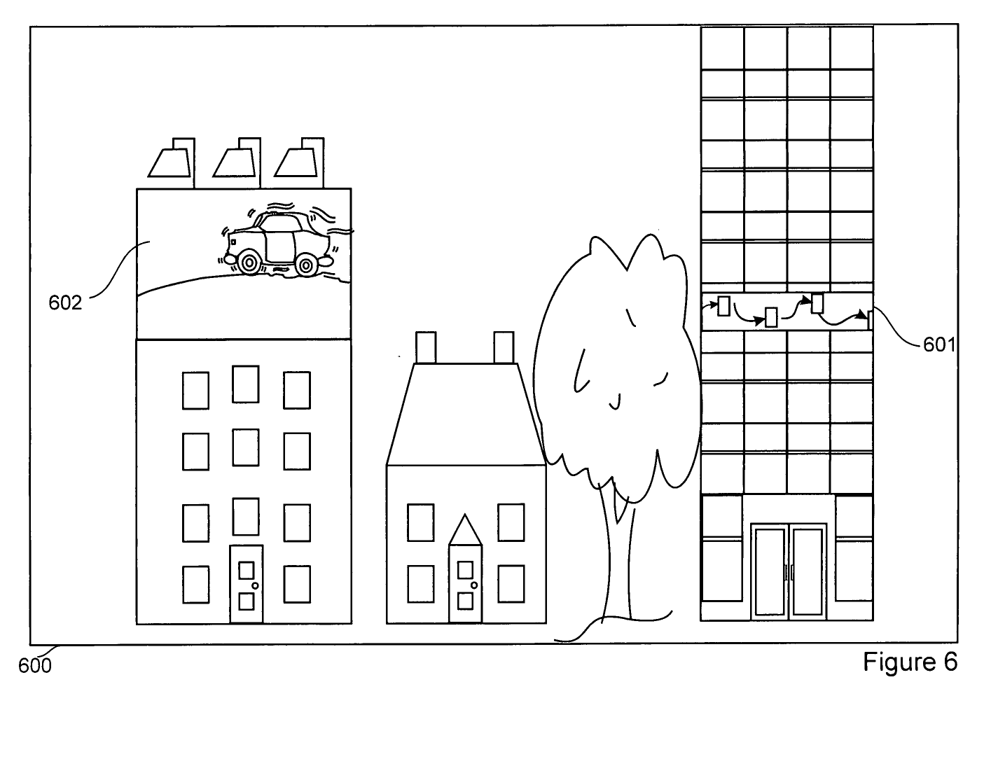

Referring now to FIG. 6, schematic screenshot 600 is shown of a video event being displayed on a video event display system (VDS) in which are inserted animated logos or advertisement sequences. In contrast to the static advertisements as described in connection with FIG. 5, the animated sequences are optionally used to display movies or snapshot sequences. For example, a series of advertising logos, which all relate to one common product, or which relate to different products, is displayed in designated spaces 601. A logo shows up for a predetermined period of time, and is then replaced by another logo. Optionally, the same logo reappears at a different designated advertising space. In another example, an animated sequence or a video is displayed in a designated space 602. The criteria for selection of logos and videos are the same as described in connection with FIG. 5. The video event source provides strict guidelines regarding formats and other specifications of still pictures as well as animated pictures.

Although the instant invention has been described with respect to specific embodiments thereof, various changes and modifications are optionally carried out by those skilled in the art without departing from the scope of the invention. Therefore, it is intended that the instant invention encompass such changes and modifications as fall within the scope of the appended claims.

What is claimed is:

1. A method of advertising for use by a Service Provider providing a video event display system connected with a wide area network, the method comprising the steps of:
providing an identification from the video event display system to the Service Provider;
providing an advertisement from a plurality of advertisements to the video event display system;
initializing the video event display system for displaying a video event and for displaying the advertisement;
displaying a video event on the video event display system; and
displaying the advertisement on the video event display system, when the video event is not being displayed.

2. A method of advertising for use by a Service Provider according to claim 1, wherein the step of providing an identification includes providing a customer personal profile, the customer personal profile for use in determining restrictions on video events provided to the video event display system, and wherein the step of providing is performed in dependence upon the provided customer personal profile.

3. A method of advertising for use by a Service Provider according to claim 2, wherein the customer personal profile is determined from data collected by the customer's Service Provider.

4. A method of advertising for use by a Service Provider according to claim 1, wherein a frequency of displaying the advertisement on the video event display system is determined according to a fee charged to the customer for connecting to the Service Provider.

5. A method of advertising for use by a Service Provider according to claim 1, wherein the step of providing an advertisement out of a plurality of advertisements to the video event display system includes a step of providing the advertisement out of a plurality of advertisements to a temporary buffer, and storing said advertisement in said temporary buffer.

6. A method of advertising for use by a Service Provider according to claim 5, wherein in the step of displaying an advertisement on the video event display system the advertisement stored in the temporary buffer is displayed on the video event display system whenever the video event display system is initialized but idle.

7. A method of advertising for use by a Service Provider according to claim 5, wherein in the step of displaying an advertisement on the video event display system the advertisement stored in the temporary buffer is displayed on the video event display system whenever the video event displayed on the video event display system is interrupted.

8. A method of advertising for use by a Service Provider according to claim 5, further comprising the step of:
refreshing the advertisement stored in the temporary buffer by providingg and storing another advertisement out of the plurality of advertisements in the temporary buffer.

9. A method of advertising for use by a Service Provider according to claim 8, wherein refreshing the temporary buffer is done periodically with a predetermined time interval.

10. A method of advertising for use by a Service Provider according to claim 5, wherein memory resources of the video event display system serve as the temporary buffer.

11. A method of advertising for use by a Service Provider according to claim 5, wherein memory resources of a connection device establishing a connection between the video event display system and the Service Provider serve as the temporary buffer.

12. A method of advertising for use by a Service Provider according to claim 1, wherein the video event display system comprises either one of set-top box, a gaming console, or a set-top box gaming system.

13. A storage medium having stored therein data, the data for performing the steps of:
providing an identification from a video event display system to a Service Provider;
providing an advertisement from a plurality of advertisements to the video event display system;
initializing the video event display system for displaying a video event and for displaying the advertisement;
displaying a video event on the video event display system; and
displaying the advertisement on the video event display system, when the video event is not being displayed.

14. A storage medium having stored therein data according to claim 13, wherein the data for performing the step of providing an identification include data for performing the step of providing a customer personal profile, the customer personal profile for use in determining restrictions on video events provided to the video event display system, and wherein the data for performing the step of providing includes data for performing the step of providing in dependence upon the provided customer personal profile.

15. A storage medium having stored therein data according to claim 14, wherein the customer personal profile is determined from data collected by the customer's Service Provider.

16. A storage medium having stored therein data according to claim 13, wherein the data include data for determining a frequency of displaying the advertisement on the video event display system according to a fee charged to the customer for connecting to the Service Provider.

17. A storage medium having stored therein data according to claim 13, wherein the data for performing the step of providing an advertisement out of a plurality of advertisements to the video event display system includes data for performing a step of providing the advertisement out of a plurality of advertisements to a temporary buffer, and storing said advertisement in said temporary buffer.

18. A storage medium having stored therein data according to claim 17, wherein the data for performing the step of displaying an advertisement on the video event display system include data for performing the step of displaying the advertisement stored in the temporary buffer on the video event display system whenever the video event display system is initialized but idle.

19. A storage medium having stored therein data according to claim 17, wherein the data for performing the step of displaying an advertisement on video event display system include data for performing the step of displaying the advertisement stored in the temporary buffer on the video event display system whenever the video event displayed on the video event display system is interrupted.

20. A storage medium having stored therein data according to claim 17, the data further comprising data for performing the step of refreshing the advertisement stored in the temporary buffer by providing and storing another advertisement out of the plurality of advertisements in the temporary buffer.

21. A storage medium having stored therein data according to claim 20, wherein the data for performing the step of refreshing the temporary buffer include data for performing the step of refreshing the temporary buffer periodically with a predetermined time interval.

22. A storage medium having stored therein data according to claim 17, wherein memory resources of the video event display system serve as the temporary buffer.

23. A storage medium having stored therein data according to claim 17, wherein memory resources of a connection device establishing a connection between the video event display system and the Service Provider serve as the temporary buffer.

24. A storage medium having stored therein data according to claim 17, wherein the video event display system comprises either one of set-top box, a gaming console, or a set-top box gaming system.

25. A storage medium having stored therein data, the data for performing the steps of:
loading a video event stored on a local storage device onto a video event display system;
loading an advertisement out of a plurality of advertisements stored on the local storage device to the video event display system;
initializing the video event display system for displaying the video event and for displaying the advertisement;
displaying the video event on the video event display system; and
displaying the advertisement on video event display system.

26. A storage medium having stored therein data according to claim 25, wherein the video event display system comprises a set-top box.

27. A storage medium having stored therein data according to claim 26, wherein the video event display system comprises a set-top box emulating a gaming console.

28. A storage medium having stored therein data according to claim 25, wherein the video event display system comprises a gaming console.

29. A storage medium having stored therein data according to claim 25, wherein the data include a frequency of displaying the advertisement on the video event display system, the frequency being determined according to a price paid by a customer for buying the local storage device comprising the video event and the plurality of advertisements.

30. A storage medium having stored therein data according to claim 25, wherein the video event display system comprises either one of set-top box, a gaming console, or a set-top box gaming system.

31. A system for advertising for use by a Service Provider providing a video event display system connected with a wide area network, the method comprising the steps of:
means for providing an identification from the video event display system to the Service Provider;
means for providing an advertisement from a plurality of advertisements to the video event display system;
means for initializing the video event display system for displaying a video event and for displaying the advertisement;
means for displaying a video event on the video event display system; and
means for displaying the advertisement on the video event display system, when the video event is not being displayed.
